(19) United States
(12) Patent Application Publication
(10) Pub. No.: US 2017/0082280 A1
(43) Pub. Date: Mar. 23, 2017

(54) Paddle Light

(71) Applicant: Jon Reiser, Stony Point, NY (US)

(72) Inventor: Jon Reiser, Stony Point, NY (US)

(21) Appl. No.: 14/859,226

(22) Filed: Sep. 18, 2015

(51) Int. Cl. F21V 33/00; F21V 31/00; F21V 19/00; F21L 4/02; F21V 23/04

(52) U.S. Cl. CPC F21V 33/0064; F21L 4/02; F21V 23/04; F21V 19/0055; F21V 31/00; F21Y 2101/02

(57) ABSTRACT

A lighting device is provided for removably attaching on a Stop/Slow sign paddle to provide enhanced visibility and safety. The lighting device includes a front box member that has at least one strip of red colored LED lights on its front side to be positioned below STOP sign of the paddle, a back box member having at least one strip of green colored LED lights on its front side to be positioned below the SLOW sign of the paddle, a clamp connecting the front box member and the back box member and having a central hollow region through which said pole of the paddle passes through, a means of connecting the clamp to said pole, a white colored LED light mounted adjustably on top side of front box member, a white colored LED light mounted adjustable on top side of back box member, and at least one battery to power the LED lights.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of Invention

The present invention generally relates to a lighting device. More particularly, the present invention relates to “a lighting device for STOP/SLOW sign paddles for enhanced visibility and safety”.

(2) Background of Invention

Sometimes, road conditions require a flagman to use a STOP/SLOW sign, know as a paddle, to control traffic at work zones. Similarly, in the construction industry, most flagmen use a stop or slow paddle to direct traffic. STOP/SLOW paddles typically have a “STOP” message on side of the paddle, and a “SLOW” message on the other side of the paddle. The “STOP” sign is used to hold the movement of traffic, while the “SLOW” sign helps slowdown the traffic, so as to prevent traffic problems, such as collisions of vehicles or chain reaction pile-ups in a location. During bad weather or low visibility, it is difficult for drivers to see the flagman holding the stop or slow paddle. This affects the work zone, and creates very hazardous problems. Furthermore, if the driver does not see a flagman and hits him/her with the vehicle, the flagman may suffer injury, which may be fatal. While driving into a work zone, with all of the cones and flashing lights on construction trucks, the driver could become distracted and lose the sight of the flagman. Hence, it is necessary that the visibility of the paddle is enhanced. A solution to this problem is to provide lighting on the STOP/SLOW sign. Some models of the stop or slow paddle have been provided with a fully lighted sign. For example, U.S. Pat. No. 5,755,051 A, issued to Edward J. Zumbuhl on May 26, 1998, discloses a Stop/Slow warning sign that has battery powered light assemblies to produce light on the sign. Similarly, U.S. Pat. No. 5,023,607 A, issued to Staten Roy G Zumbuhl on Jun. 11, 1991 discloses a pedestrian crossing safety apparatus that has a series of flashing light sets mounted on the upper, lower, right side, and left side portions of its border. Also, U.S. Pat. No. 6,266,903 B1, issued to Flaggin, Inc. Jul. 31, 2001, discloses a hand-held portable sign that has pulsed light to increase visibility. The lights are powered with the help of battery. However, these methods and devices cost a lot more than regular paddles. In such paddles, if these lights break, a whole new paddle needs to be purchased. Hence, there is a need for a method or device to use lights to enhance the visibility of the paddle in a cost-effective and effective way.

It is an aspect of the invention to overcome or alleviate the problems of the prior art.

This permits the use of the present invention, which enhances the prior art of lighting systems for STOP/SLOW sign paddles for cost-effectively and efficiently enhancing both the visibility of the signs, and safety.

### BRIEF SUMMARY OF THE INVENTION

In view of the foregoing, one aspect of the various disclosed embodiments of the present invention is to provide a lighting device for STOP/SLOW sign paddles.

Preferably, the lighting device for STOP/SLOW sign paddles addresses, or at least ameliorates, one or more of the problems described above. To this end, the present invention, related to a lighting device for STOP/SLOW sign paddles with some unique aspects, is disclosed.

Accordingly, it is a primary objective of the present invention to provide a lighting device for STOP/SLOW sign paddles that can be removably connected to a STOP/SLOW sign paddle to enhance the visibility of the STOP sign and SLOW sign on the paddle. The lighting device also increases safety for the flagman and coworkers. The lighting device is especially useful during bad weather or low visibility weather conditions, when it is difficult for drivers to see the flagman and the STOP/SLOW paddle.

It is an objective of the present invention that the lighting device for STOP/SLOW sign paddles is cost efficient.

It is an objective of the present invention that the lighting device for STOP/SLOW sign paddles is made from a sturdy material, for durability.

Other objectives of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 shows the top perspective view of a lighting device for STOP/SLOW sign paddles.

FIG. 2 shows the front perspective view of the lighting device for STOP/SLOW sign paddles.

FIG. 3 shows a perspective view of the lighting device installed on a STOP/SLOW sign paddle showing the side of the paddle that has the STOP sign.

FIG. 4 shows a perspective view of the lighting device installed on a STOP/SLOW sign paddles showing the side of the paddle that has the SLOW sign.

FIG. 5 shows a front perspective view of the box member of the lighting device showing a series of LED lights.

### DETAIL DESCRIPTION OF THE INVENTION

The following detailed description of the present invention enables teaching of the invention and its best, currently known embodiment. Those skilled in the art can understand that many changes can be made to the embodiments described while still obtaining the beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide a lighting device which can be removably attached on a Stop/Slow sign paddle to provide enhanced visibility and safety. The lighting device, upon installation, shows red colored LED lights below the STOP sign and green colored LED lights below the SLOW sign. Furthermore, the lighting device has white colored LED lights to shine over the STOP and SLOW sign. Accordingly, the specific embodiments discussed herein are merely illustrative of specific manners in which to make and use this invention, and are not intended to represent an exhaustive list of all possible structure and processes of the present invention.

Embodiments of the lighting device are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

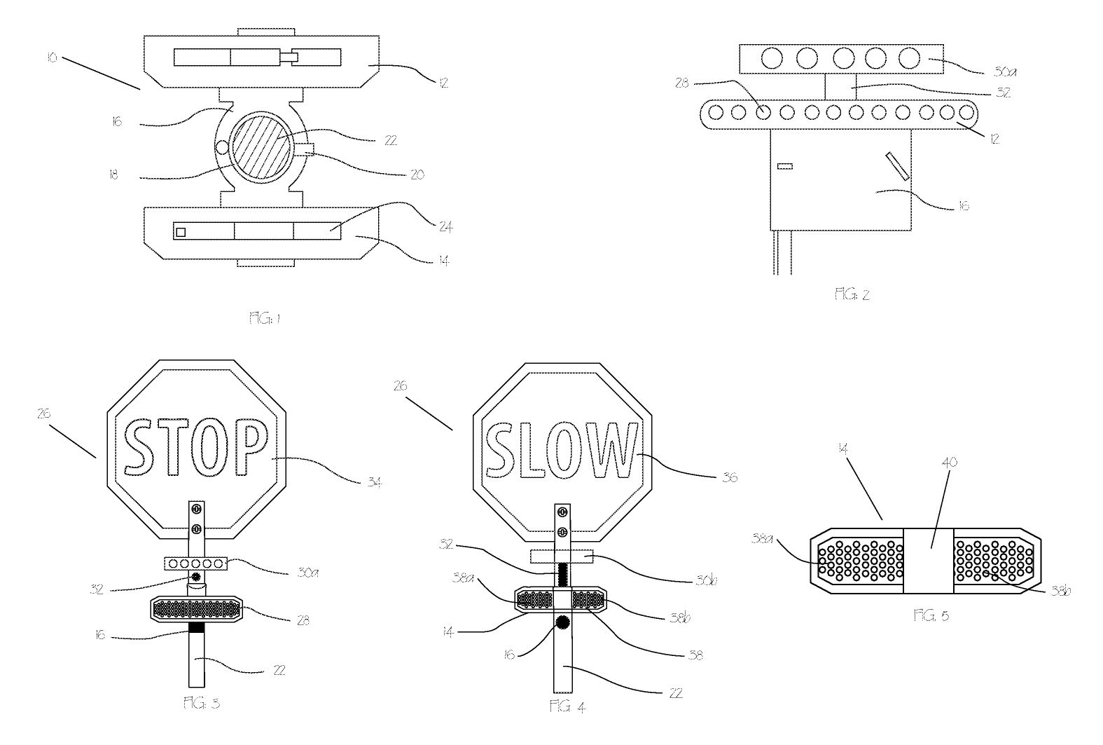

Aspects of the present inventive subject matter are described with reference to the figures. The present invention provides a lighting device for use as an add-on light on a Stop/Slow sign paddle used by a flagman to control or direct traffic. FIGS. 1-5 show a preferred embodiment of the present invention. The lighting device 10 includes a front box member 12 that has a front, back, top, and bottom side, a back box member 14 that has a front, back, top, and bottom side, at least one strip of red colored LED lights 28 on the front side of the front box member 12, at least one strip of green colored LED lights 38 on the back side of the back box member 14, and a clamp 16 to connect the front box member 12 and the back box member 14. The clamp 16 has a central hollow region 18. The clamp 16 removably attaches the lighting device 10 to the paddle 26 by allowing said pole 22 of the paddle 26 to pass through the central hollow region 18 of the clamp 16. The clamp 16 holds the lighting device 10 in its position on the paddle 26 by means of a screw bolt-wingnut 20 or lock. The screw bolt passes through a hole on one side of the clamp 16, a hole in said pole 22 of the paddle 26, and finally a hole on the other side of the clamp 16. The holes on the two sides of the clamp 16 are positioned in a straight line, to be locked with a wingnut. The clamp 16 has a means of attachments known in the art for increasing or decreasing the dimensions of the clamp 16 to enable the clamp 16 to fit post of any size. The lighting device 10 is clamped on said pole 22 of the paddle 26 below the stop or slow sign. As shown in FIGS. 4 & 5, the lighting device 10 is positioned on the paddle 26 in a manner so that the front box member 12 has at least one strip of red colored LED lights 28 on the side of the paddle 26 showing the STOP sign 34, while the back box member 14 has at least one strip of green colored LED light 38 on the side of the paddle 26 showing the slow sign. It is preferred that the strip of red colored LED light and strip of green colored LED light are both 6 inches or 8 inches wide. Furthermore, the strip of red colored LED light 28 is recessed into a waterproof case in the front box member 12. Similarly, the strip of green colored LED light is recessed into a waterproof case in the back box member 14. The waterproof case not only protects the LED lights from damage from water during bad weather conditions and accidental exposure to water, but also prevents light over shine.

Again referring to FIGS. 2, 3 & 4 showing a preferred embodiment of the present invention, the lighting device 10 also has a white colored LED light 30a connected to said top side of the front box member 12, and a white colored LED light 30b connected on top side of the back box member 14. Each of these two white colored LED light 30a, 30b is attached to a top angled or swivel mount 32, while the mount 32 is itself connected to the box member such that the white colored LED lights 30a, 30b are adjustable to appropriately shine the light of the white colored LED lights 30a, 30b on the STOP sign 34 and SLOW sign 36 respectively to allow enhanced visibility of these signs. The white colored LED light is preferably positioned in the center of top side of the box member. Referring to FIGS. 4 & 5 showing an exemplary representation of a preferred embodiment of the present invention, each of the box members has two strips of the colored LED lights separated by a space 40. The space 40 can be used to attach a logo, including but not limited to a company logo, a brand logo, etc. The white colored LED light 30b is attached in the center of said top side of the box member shining between the two strips of the colored LED lights, which are green colored LED lights 38a, 38b in this example. The white colored LED light is preferably 1 or 2 inch in size.

The lighting system has at least one battery to power the white colored LED lights, red colored LED lights, and green colored LED lights. The battery may be positioned in clamp. Alternatively, the battery may be positioned inside a compartment 24 in the front box member or the back box member, as shown in FIG. 1. The compartment in the lighting device that houses the battery is waterproof. The LED lights, besides being long-lasting, consumes less power. Hence, it will require fewer batteries, resulting in low manufacturing and operational costs. The lighting device has an on/off switch for switching on or shutting off the LED lights. The on/off switch is preferably placed on the outer surface of the clamp. The LED lights can be switched on or off, or they can be run in strobe or blink mode. This way, oncoming drivers are able to see the sign on the stop or slow paddle easily. In a preferred embodiment of the present invention, the lighting device has only one on/off switch for switching on or shutting off all the red colored LED lights, green colored LED lights, and white colored LED lights.

The different components of the lighting device are made of lightweight material, preferably plastic molding. Furthermore, the lighting device of the present invention can be provided in different sizes for use for different purposes. The lighting device is easy to remove from the paddle by unclamping it. Hence, it is easy to replace a faulty or damaged lighting device. During the daytime, the lighting device can be removed from the paddle, if desired. The lighting device can be connected to the paddle in fog, dusk, dawn, and nighttime. The lighting device will greatly help people slow down and understand what the flagman wants them to do. As the lights of the lighting device installed on the STOP/SLOW sign paddle are easily seen by drivers, the lighting device also increases the safety of the Flagman and workers.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the figures of the drawings, it should be understood that other and further modifications, apart from those shown or suggested herein, may be made within the spirit and scope of this invention.

I claim:

1. A lighting device removably attached on a Stop/Slow sign paddle comprises; a front box member having a front, back, top and bottom side;
a back box member having a front, back, top and bottom side;
a pole;
at least one strip of red colored LED lights on said front side of said front box member;
at least one strip of green colored LED lights on said front side of said back box member;
one white colored LED light mounted on said top side of front box member shining light on STOP sign;
one white colored LED light mounted on said top side of said back box member shining light on SLOW sign;
a clamp connecting said front box member and said back box member, said clamp having a central hollow region;
a means of connecting said clamp to said pole of the paddle;
at least one battery to power said at least one strip of red colored LED lights, said at least one of green colored LED lights and said white colored LED lights;
a means of switching on/off red colored LED lights, green colored LED lights and white colored LED lights;
wherein said clamp removably attaches the lighting device to said paddle by allowing said pole of the paddle to pass through the central hollow region of the clamp so as to position said front box member on the side of paddle showing STOP sign, and to position said back box member on the side of paddle showing SLOW sign.

2. The lighting device of claim 1, wherein said means of connecting clamp to said pole of the paddle is screw bolt-wingnut, the clamp having two holes on opposite sides of said central hollow region, said screw bolt passes through the hole on one side of the clamp, a hole in said pole of the paddle and the hole on other side of the clamp, to be locked with a wingnut.

3. The lighting device of claim 1, wherein said at least one strip of red colored LED light is recessed into a waterproof case in said front box member and said at least one strip of green colored LED light is recessed into a waterproof case in said back box member.

4. The lighting device of claim 1, wherein said front box member has two strips of red colored LED lights, said two strips of red colored LED lights are separated by a space.

5. The lighting device of claim 1, wherein said back box member has two strips of green colored LED lights, said two strips of green colored LED lights are separated by a space.

6. The lighting device of claim 1, wherein said one white colored LED light is adjustably mounted on said top side of front box member and said one white colored LED light is adjustably mounted on said top side of said back box member.

7. The lighting device of claim 1, wherein said one white colored LED light is adjustably mounted on said top side of front box member by means of a top angled mount and said one white colored LED light is adjustably mounted on said top side of said back box member by means of a top angled mount.

8. The lighting device of claim 1, wherein said one white colored LED light is adjustably mounted on said top side of front box member by means of a swivel mount and said one white colored LED light is adjustably mounted on said top side of said back box member by means of a swivel mount.

9. The lighting device of claim 1, wherein the clamp further has means of attachments for increasing or decreasing the dimensions of the clamp.

10. The lighting device of claim 1, wherein said at least one battery is housed in a waterproof compartment.

11. The lighting device of claim 1, wherein the lighting device is made of lightweight material.

12. The lighting device of claim 1, wherein the lighting device is made of plastic molding.
